(19) United States
(12) Patent Application Publication
(10) Pub. No.: US 2003/0179645 A1
(43) Pub. Date: Sep. 25, 2003

(54) Electric mixer

(76) Inventor: Yong-Suek Seul, Seoul (KR)

Correspondence Address: Finnegan, Henderson, Farabow,, Garrett & Dunner, L.L.P., 1300 I Street, N.W., Washington, DC, 20005-3315, US

(21) Appl. No.: 10/391,586

(22) Filed: Mar. 20, 2003

(30) Foreign Application Priority Data
Mar. 21, 2002 (KR) 10-2002-0015320

(51) Int. Cl. B01F 15/00

(52) U.S. Cl. 366/142; 366/205; 366/314

(57) ABSTRACT

The present invention relates to an electric mixer for performing the functions of pulverizing and mixing various kinds of cereals, grains, vegetables and fruits. Especially, this mixer has plural luminous lamps, which are able to emit the light, on the upper part of the lower body of the electric mixer. Therefore, when the users use the mixer, because of lights permeated into the inside of the upper body, the lamps could indicate visually that the mixer is working normally, and the lamps could also indicate aurally that the mixer is working normally because all kinds of sounds to be memorized by the audio synthesizer device are transmitted to outside.

### BACKGROUND OF INVENTION

1. Field of the Invention

The present invention relates to an electric mixer for performing the functions of pulverizing and mixing various kinds of cereals, grains, vegetables and fruits. Especially, this mixer has plural luminous lamps, which are able to emit the light, on the upper part of the lower body of the electric mixer. Therefore, when the users use the mixer, because of lights permeated into the inside of the upper body, the lamps could indicate visually that the mixer is working normally, and the lamps could also indicate aurally that the mixer is working normally because all kinds of sounds to be memorized by the audio synthesizer device are emitted to outside.

2. Description of Related Prior Art

As described in FIG. 5, the prior electric mixer is composed of a lower body 9 that is able to insert the motor, blades of the pulverization or blades of the mixer 3 connected to the rotational axis of this motor (not shown) and rotatable at the lower part of upper body 7, a lid 1 covering this upper body 7, and all kinds of switches 5, 10, 11.

According to the above mentioned construction, when the power is provided to the switches 5, 10, the motor is rotated and then the blades of the pulverization or blades of the mixer 3 connected to the rotational axial of this motor are rotated.

Therefore, all kinds of vegetables and fruits contained in the upper body 7 are pulverized or mixed by the blades of the pulverization or blades of the mixer 3.

Also, while being pulverized and mixed, since the users know the processing state while they see blades of the pulverization or blades of the mixer 3 rotating, there is a problem that the users may be bored.

Therefore, the above mentioned mixer, generally, does not have any other special objects except pulverizing or mixing contents which is contained in the upper body 7.

That is, since generally used mixer is made for a normal person, a visually handicapped person and an aurally handicapped person could not use it safely.

### SUMMARY OF THE INVENTION

To solve the above mentioned problem in the conventional apparatus, it is an object of the present invention to provide an electric mixer, which, beside performing general functions of conventional mixers such as pulverizing or mixing, the visually handicapped and aurally handicapped can use safely by watching pulverizing and mixing of a mixer, because visual effects produced by lamps which emit lights from inside of the mixer and hearing effects produced by a chip, into which audio synthesizer device is embedded, emitting various kinds of memorized sounds.

That is, while the mixer is operating, the aurally handicapped users can use the mixer safely by the emitted lights from inside of the mixer and the visually handicapped users can use the mixer safely by the sounds stored in the chips including audio synthesizer elements.

As shown in FIG. 1, the present invention is composed of a lower body 9 that is able to insert a motor, blades of the pulverization or blades of the mixer 3 connected to the rotational axial 12 of this motor and rotatable at the lower part of upper body 7, a lid 1 covering this upper body 7 and all kinds of switches 5, 10, 11.

The present invention provides an electric mixer that has a luminous lamp 8 that is emitting much lights and is formed on the upper part of the lower body 9, wherein the luminous lamp 8 transmits lights from inside to outside through the lower part of the upper body 7.

Further, the present invention provides a mixer that includes prominence and depression 13 in the inside walls of the upper body 7.

Moreover, the present invention provides an electric mixer in which the lights of the luminous lamp 8 are emitted sequentially.

Further, the present invention provides an electric mixer in which the lights of the luminous lamp 8 are emitted to the outside periphery of upper body 7 and transmitted to outside.

Further, the present invention provides a mixer in which the luminous lamp emits remote infrared rays.

Further, the present invention provides a mixer which the luminous lamp 8 includes a sterilization lamp.

Still further, the present invention provides an electric mixer in which the luminous lamp 8 is mounted on the upper body 7.

Additionally, the present invention provides an electric mixer including chips of audio synthesizer device into which the sounds and music are embedded are connected into a circuit section inside the lower body 9.

### BRIEF DESCRIPTION OF DRAWINGS

FIG. 1 is a perspective illustration which depicts the separated state of present invention;

FIG. 2 is a perspective illustration which depicts the conjoined state of present invention;

FIG. 3 is a schematic cross-sectional view which depicts the state which the lights of a luminous lamp of an electric mixer of the present invention are emitted to outside;

FIG. 4 is a cross-sectional view which depicts the state of mounting the luminous lamp to the upper body of the present invention; and

FIG. 5 is a perspective illustration which depicts a prior mixer.

### DETAILED DESCRIPTION OF THE PREFERRED EMBODIMENT

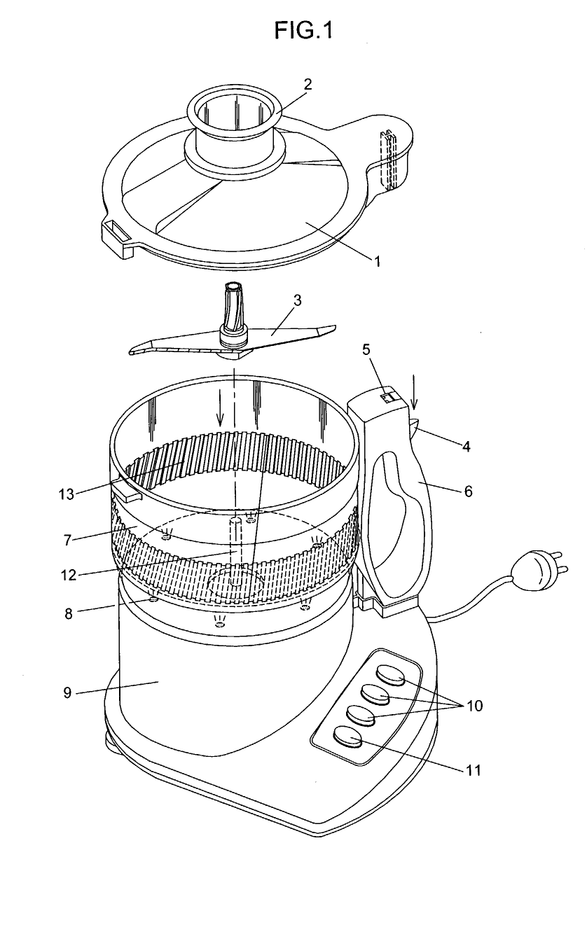

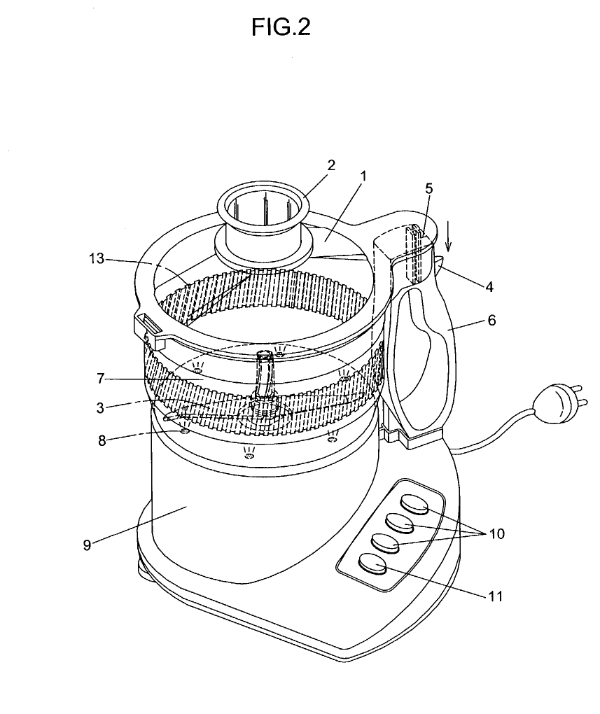

As shown in FIG. 1, through the rotational axis 12 of a motor (not shown) mounted inside the lower body 9, power supply is transmitted. And on one side of the lower body 9, there are installed various kinds of switches 5, 10, 11 which operate the motor, that is, on switch 10 which mixes and cut-pulverizes, off switch 11 which blocks the power supply, and safety switch 5 and handle 6 which are designed to provide stable states of the mixer's operations.

Since prominence and depression 13 are formed in the inside walls of the upper body 7, when the mixer starts to operate, the contents contained in the inside are pulverized. At this time, as the contents are collided against the prominence and depression 13, the pulverization of the contents is improved.

Further, there are blades of the pulverization or blades of the mixer 3 which are connected to the rotational axis 12 of the motor inside the upper body 7. The motor is arranged in the lower body 9. The upper body 7 is connected to the lower body 9 and can contain various kinds of cereals, vegetables and fruits.

Further, on the section at which the upper part of the lower body 9 and lower part of the upper body 7 contact, a plurality of luminous lamps 8 which emit lights are arranged. Therefore when the power supply is provided, the lights of the lamp 8 are emitted to inside and outside of upper body 7.

Further, since the luminous lamp 8 is also arranged on the upper body 7, the lights can be emitted to outside.

And if the luminous lamp 8 includes a lamp 8 which emits remote infrared rays, during the pulverization of a mixer, various kinds of nutrients and minerals are prevented from being destroyed. Also, the bacteria included in the pulverized contents of the mixer are sterilized and thereby the foods which are not contaminated are provided.

At this time, the luminous lamp 8 can emit the lights simultaneously or depending on the circumstances, the lamp 8 can emit the lights sequentially.

Besides them, since the chips which store sounds or music are connected to a circuit section (not shown) formed in the inside of the lower body 9, and thereby sounds can be emitted outside, the operation status of a mixer will be understood by the aurally and visually handicapped persons.

A lid 1 is arranged on the upper part of the upper body 7. When the blades of the pulverization or blades of the mixer 3 operate, the contents contained inside a mixer are prevented from being discharged outside. When the lid 1 is combined into the upper body 7, the power supply is provided by the safety switch 5 and when the lid 1 is opened, the operations of a mixer are stopped automatically, thereby providing a safety in use.

Moreover, the upper body 7 is composed of a transparent case through which the users can see the lights emitted from the luminous lamp 8 inside of a mixer. We will explain the present invention by using a preferred embodiment as follows.

First of all, the users select the cereals, fruits and vegetables and put them inside the upper body 7 connected to the lower body 9.

At this time, the contents of a mixer are pulverized by blades of pulverization or blades of a mixer 3, and the pulverization is accelerated because the pulverized contents collide against the prominence and depression 13.

After putting them into the upper body 7 and closing the lid 1, safety switch 5 formed on one side of the handle 6 of the lower body 9 is contacted. Then, the users select and press one of the plurality of on-switch 10 to determine whether pulverization operation is performed or not, the power supply is provided and then the motor is operated. Due to the motor's operations, the blades of the pulverization or blades of the mixer 3 connected to the rotational axis 12 of the motor are rotated and thereby the contents are mixed or pulverized.

At this time, if the luminous lamp 8 includes a lamp 8 which emits remote infrared rays, since the remote infrared rays are emitted, the nutrients of pulverized contents are prevented from being destroyed. Also, the pulverized contents are sterilized and thereby the fresh foods are obtained.

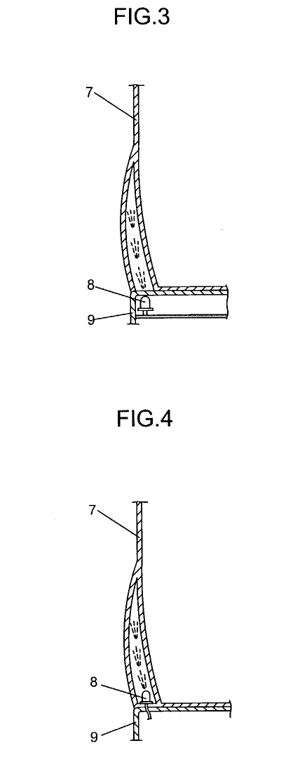

At the same time, the power supply is provided to a plurality of luminous lamps 8 which indicate to the aurally and visually handicapped persons (or the users) that the mixer is now operating. The luminous lamps 8 are arranged on the upper part of the lower body 9. Then the lights are emitted from the a plurality of luminous lamps 8 and thus the lights are permeated into the inside and outside of upper body 7 connected to the lower body 9 (see FIG. 3). Accordingly, the lights are illuminated on the contents.

Further, various kinds of memorized sounds are emitted outside from the chips of lower body 9, which are connected to the circuit section and into which sounds or music are embedded (audio synthesizer device) (not shown). At the same time, the state that the mixer is operating is reported to the visually handicapped persons with the emitted sounds.

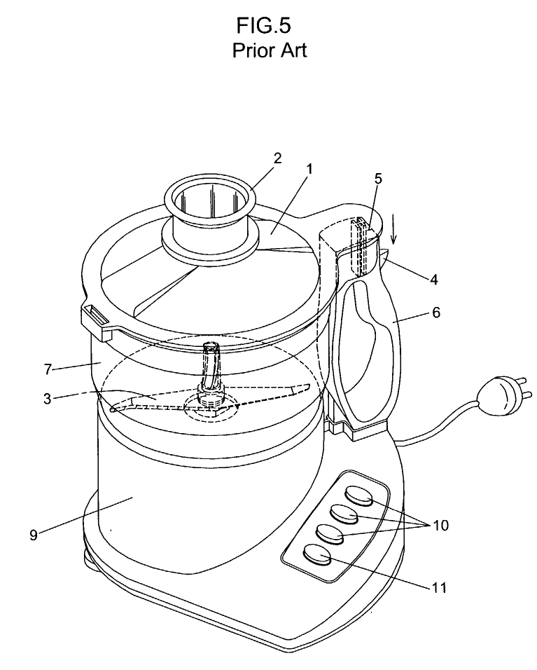

The present invention describes the case that the luminous lamp 8 is mounted on the lower body 9, but the present invention is not limited to this. As shown in FIG. 4, even when the luminous lamp 8 is mounted on the upper body 7, same operations are performed.

Further, as explained in the embodiment of the present invention, the structure having the luminous lamp 8 mounted on the upper body 7 to illuminate the lights to outside is not limited to the structure described in FIG. 4. Even if the luminous lamp 8 is mounted on one of any parts of the upper body 7, same structure is formed.

In this way, due to the above-mentioned operations, after the completion of processing the contents contained in the inside of the upper body 7, if the users press the off-switch 11, the power supply is not provided and then the motor's operations are stopped. At this time, the luminous lamp 8 does not emit the lights and the sounds are not reproduced from the chips storing memorized sounds.

After the completion of above processing, the users can pour the processed contents contained in the upper body 7 into other containers and then use them.

At this time, even if the users open the lid 1, the contact point of the safety switch 5 is cut off and the motor's operation is stopped. Therefore, the dangerous accidents are prevented in advance.

Further, the reference number 4 shown in the drawings is a pressing pin which changes the state that one side of the lid 1 is inserted and fixed into the handle 6. If this pressing pin is pressed, the lid 1 inserted into the handle 6 is excluded and the upper body 7 is opened. Also, the reference number 2 is a hole for pouring the remaining contents while pouring the contents into the upper body 7 even after lid 1 is closed.

From the above description, the present invention enables the users to operate the mixer safely during the mixing and pulverization by indicating mixer's operations such as the mixing and pulverization to the aurally and visually handicapped persons, visually and aurally,

In addition to it, the normal persons use the mixer joyfully without feeling the boredom because the users can watch the operation state.

Consequently, the users can use the mixer safely without feeling any boredom and dangers.

What is claimed is:

1. A mixer comprising:
a lower body and an upper body, the lower body including a motor;
blades rotatable within the upper body around a rotational axis of the motor; and
at least one lamp emitting lights outside the mixer through at least a part of the upper body.

2. The mixer according to claim 1, wherein the lights of the at least one lamp are emitted outside the mixer through an outer periphery of the upper body.

3. The mixer according to claim 1, wherein the at least one lamp is mounted on the upper body.

4. The mixer according to claim 1, wherein the at least one lamp is mounted on an upper part of the lower body.

5. The mixer according to claim 1, wherein the lights of the at least one lamp are emitted sequentially.

6. The mixer according to claim 5, wherein the lights of the at least one lamp are emitted outside the mixer through an outer periphery of the upper body.

7. The mixer according to claim 5, wherein the at least one lamp is mounted on the upper body.

8. The mixer according to claim 5, wherein the at least one lamp is mounted on an upper part of the lower body.

9. The mixer according to claim 1, further comprising chips having sounds embedded therein, the chips being positioned inside the lower body and connected to a circuit section.

10. The mixer according to claim 1, wherein the upper body includes protrusions and recesses formed in inside walls thereof.

11. The mixer according to claim 1, wherein the at least one lamp includes an infrared lamp emitting remote infrared rays.

12. The mixer according to claim 1, wherein the at least one lamp includes a sterilization lamp.

13. The mixer according to claim 1, wherein the lights of the at least one lamp are emitted outside the mixer through a lower part of the upper body.

14. A mixer comprising:
a lower body and an upper body, the lower body including a motor;
blades rotatable within the upper body around a rotational axis of the motor; and
at least one lamp emitting lights outside the mixer through at least a part of the upper body when the mixer is electrically activated.

15. The mixer according to claim 14, wherein the at least one lamp is mounted on the upper body.

16. The mixer according to claim 14, wherein the at least one lamp is mounted on an upper part of the lower body.

17. The mixer according to claim 14, wherein the lights of the at least one lamp are emitted sequentially.

18. The mixer according to claim 14, wherein the upper body includes protrusions and recesses formed in inside walls thereof.

19. The mixer according to claim 14, further comprising chips having sounds embedded therein, the chips being positioned inside the lower body and connected to a circuit section.

20. The mixer according to claim 14, wherein the lights of the at least one lamp are emitted outside the mixer through a lower part of the upper body.
